(19) United States
(12) Patent Application Publication
(10) Pub. No.: US 2018/0201520 A1
(43) Pub. Date: Jul. 19, 2018

(54) BIOCHAR AND METHODS OF REMOVING CONTAMINANTS FROM WATER

(71) Applicant: Manashree Seth Padiyath, Woodbury, MN (US)

(72) Inventor: Manashree Seth Padiyath, Woodbury, MN (US)

(21) Appl. No.: 15/858,638

(22) Filed: Dec. 29, 2017

Related U.S. Application Data
(60) Provisional application No. 62/446,293, filed on Jan. 13, 2017.

(51) Int. Cl. C02F 1/28; B01J 20/20; B01J 20/28; B01J 20/30

(52) U.S. Cl. CPC C02F 1/283; B01J 20/20; C02F 2101/20; B01J 20/3078; B01J 20/28064

(57) ABSTRACT

A biochar is disclosed that includes a biochar of one or more plant members of the Apiaceae plant family.

### FIELD OF THE INVENTION

The present invention relates generally to a method of remediation, and more specifically to using biochar for removal of lead and other metal pollutants from solutions such as water.

### BACKGROUND OF THE INVENTION

Heavy metals are an environmental hazard and a human health concern. Such heavy metal contaminants can include, for example: cadmium, chromium, copper, lead, mercury, nickel, zinc, and semi-metals such as arsenic and selenium. Excessive ingestion of these metals by humans can cause accumulative poisoning, cancer, nervous system damage, and ultimately death. It is desirable for contaminated water to be treated to either remove substantially all heavy metals or to reduce the dissolved heavy metals to safe levels.

Due to the recent Flint Water Crisis in the state of Michigan in USA, much attention has been directed towards the presence of lead in water and its health implications. Lead is a potent neurotoxin, and childhood lead poisoning has an impact on many developmental and biological processes, most notably intelligence, behavior, and overall life achievement. The US Environmental Protection Agency (EPA) regulates lead in public water supplies under the Safe Drinking Water Act Lead and Copper Rule, which requires action when lead levels reach 15 parts per billion (ppb). According to the Flint water study, the lead content in several samples exceeded 100 ppb, and for one sample, the lead collected after 45 seconds of flushing exceeded 1 parts per million (ppm) (1000 ppb).

Conventional methods for removing heavy metals from water such as treatment with activated carbon (used, for example, in filters in home water purification pitchers) or more advanced technology like ion-exchange resins are effective, but are generally too expensive for use in developing countries, especially in rural areas.

Hence, an easy and efficient removal process, which is both sustainable and inexpensive, is needed.

### SUMMARY

Embodiments of the present disclosure provide methods of removing a material (e.g., a contaminant) such as one or more types of metals (e.g., heavy metals such as lead), from a fluid (e.g., water) with biochar made from plant of the Apiaceae family (e.g., Coriandrum Sativum or Cilantro), methods of making said biochar, structures including said biochar, and the like. Apiaceae or Umbelliferae, is a family of mostly aromatic flowering plants commonly known as the celery, carrot or parsley family. Included in this family are the well-known plants: angelica, anise, asafoetida, caraway, carrot, celery, chervil, coriander (cilantro), culantro, cumin, dill, fennel, parsley, and parsnip.

In one embodiment, a biochar includes a biochar of one or more plant members of the Apiaceae plant family. In some embodiments, the one or more plant members is cilantro. In some embodiments, the one or more plant members is carrot. In some embodiments, the biochar has a BET (N2) surface area greater than about 500 m2/g. In some embodiments, at least a portion of the biochar is porous. In another embodiment, a filter structure or means for filtering solutions includes the disclosed biochar.

In another embodiment, a cilantro biochar is disclosed. In yet another embodiment, a carrot biochar is disclosed. In yet another embodiment, a carrot leaves biochar is disclosed.

In another embodiment, a method of purifying a solution includes bringing the solution in contact with an Apiaceae biochar. In some embodiments, the solution is water. In some embodiments, bringing the solution in contact with the Apiaceae biochar is configured to at least partially remove one or more of any lead, copper, zinc, cadmium, nickel, chromium, iron, aluminum, cobalt, magnesium, and mercury that may be present in the solution. In some embodiments, the solution includes a detectable quantity of lead and bringing the solution in contact with the Apiaceae biochar removes the detectable quantity of lead, so that any quantity of lead remaining in the solution is substantially undetectable. In some embodiments, the Apiaceae biochar is made by thermochemically converting one or more plant members of the Apiaceae plant family, where in some embodiments, the thermochemical conversion includes pyrolysis.

In another embodiment, a method of purifying water contaminated with lead, includes the steps of: thermochemically converting cilantro to biochar; and exposing the lead contaminated water to the cilantro biochar. In some embodiments, the step of thermochemically converting cilantro to biochar includes pyrolyzing or burning or charring of cilantro.

An embodiment of a method of removing contaminants from a fluid, among others, includes exposing the said biochar and a fluid to one another, wherein the fluid includes one or more types of ions selected from a heavy metal, and a combination thereof; and adsorbing at least one type of ion onto the biochar.

An embodiment of a structure, among others, includes a biochar, where the biochar is a product of a pyrolysis of cilantro biomass. An embodiment of a structure, among others, includes a biochar, where the biochar is a product of a pyrolysis of carrot biomass.

Other structures, methods, features, and advantages of the present disclosure will be, or become, apparent to one with skill in the art upon examination of the following drawings and detailed description. It is intended that all such additional structures, methods, features, and advantages be included within this description, be within the scope of the present disclosure.

### BRIEF DESCRIPTION OF THE DRAWINGS

FIG. 1 is a Scanning Electron Microscope (SEM) image of a cilantro biochar at 500× magnification.

FIG. 2 is a Scanning Electron Microscope (SEM) image of a parsley biochar at 500× magnification.

FIG. 3 is a Scanning Electron Microscope (SEM) image of a carrot tops biochar at 500× magnification.

FIG. 4 is a Scanning Electron Microscope (SEM) image of a carrot pulp biochar at 500× magnification.

### DETAILED DESCRIPTION OF THE INVENTION

Char, charcoal and biochar are hereafter collectively referred to as biochar and refer to thermochemical degradation of biomass under limited-oxygen conditions. In some cases, a biochar product may be obtained from a thermochemical conversion, such as a pyrolysis, i.e. burning a material in an oxygen deficient environment resulting in a carbon-rich product. For example, a biochar may be obtained when an organic biomass, such as wood, leaves, or grasses are pyrolyzed i.e. heated to a point of thermal decomposition under a limited or zero supply of oxygen. Biochar of plant members of the Apiaceae plant family are disclosed herein shown in the disclosed examples to be able to function adsorbents or filters given their large surface area and microporous structure.

### EXAMPLES

1 ppm lead contaminated aqueous solution was prepared from 1000 ppm lead in dilute Nitric Acid stock solution.

Commercially available Brita® Water pitcher filter cartridge, available at many retail stores in the United States, was opened using pliers and the filtration material collected for testing.

Cilantro bunch was purchased at a Woodbury, Minn. local grocery store and the stalks were cut off and the remaining leafy portion washed and air dried for 4 hours prior to testing.

To create cilantro biomass for making biochar, cilantro was dried in a convection oven at 60 C for 120 hrs and the resulting cilantro dry biomass pyrolyzed at 500 C for 1 hr under limited O2 conditions to generate cilantro biochar for testing. To make the biochar Cilantro biomass was placed into a crucible (25 cm wide×10 cm deep) and inserted into a Lindberg box programmable furnace equipped with an airtight retort (Model 5116HR; Lindberg, Watertown, Wis.). The interior of the furnace was continually purged with N2 using a flow rate of 0.1 m3/hr. The furnace was controlled with a multiple-step pyrolysis temperature program. The furnace was initially heated to 40 C; then the temperature was ramped to 170 C at 5 C/min and was maintained at this temperature for 30 min. The temperature was then ramped to 500 C at 5 C/min, and the cilantro was subjected to pyrolysis for 1 hr. The resulting cilantro biochar was cooled in the oven under the N2 atmosphere overnight.

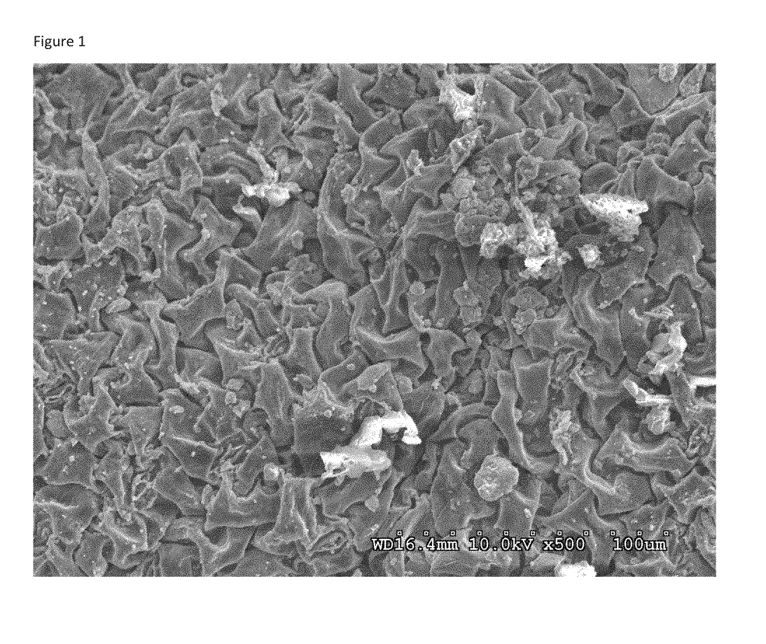

FIG. 1 is a Scanning Electron Micrograph (SEM) of the resulting cilantro biochar at a magnification of 500×. The micrograph shows that the surface of the cilantro biochar is very rough and porous.

Table 1 shows the BET (N₂) surface area:

| Material | Surface Area (m²/g) |
|---|---|
| Brita ® Filter | 6135 |
| Cilantro leaves | <1 |
| Cilantro biochar | 554 |

### Comparative Example 1 (C-1)

80 ml of 1 ppm lead contaminated water was poured into 2 labeled beakers. One teaspoon of Brita® filter material (2.613 grams) was added to each beaker. After 30 minutes about 15 ml of water was decanted off from each of the beakers into disposable cups lined with coffee filter to filter any solids out. The filtered water was poured into labeled test vials for elemental analysis to measure lead levels. The process was repeated after 2 hours and 24 hours resulting in 6 vials total.

The lead content in the reference 1 ppm lead contaminated water was also measured.

### Comparative Example 2 (C-2)

80 ml of 1 ppm lead contaminated water was poured into 2 labeled beakers. One teaspoon of Cilantro leaves (1.287 grams) were added to each beaker. After 30 minutes about 15 ml of water was decanted off from each of the beakers into disposable cups lined with coffee filter to filter any solids out. The filtered water was poured into labeled test vials for elemental analysis to measure lead levels. The process was repeated after 2 hours and 24 hours resulting in 6 vials total.

### Example 1 (1)

80 ml of 1 ppm lead contaminated water was poured into 2 labeled beakers. One teaspoon of Cilantro biochar (0.489 grams) material was added to each beaker. After 30 minutes about 15 ml of water was decanted off from each of the beakers into disposable cups lined with coffee filter to filter any solids out. The filtered water was poured into labeled test vials for elemental analysis to measure lead levels. The process was repeated after 2 hours and 24 hours resulting in 6 vials total.

Elemental analysis for lead was conducted on Thermo Scientific (Trade Mark) iCAP 7000 series ICP Spectrometer. Average ICP lead content for the 1 ppm reference solution was measured to be 1.072 ppm

Table 2 shows the ICP data on average lead content after three time intervals: 30 min, 2 hours and 24 hours.

| | | ppm Lead | ppm Lead | ppm Lead |
|---|---|---|---|---|
| Example | Material | at 30 min | at 2 hours | at 24 hours |
| C-1 | Brita | 0.459 ppm | 0.277 ppm | Undetectable |
| | filter | | | (<0.01 ppm) |
| C-2 | Cilantro | 1.072 ppm | 1.032 ppm | 1.071 ppm |
| | leaves | | | |
| 1 | Cilantro | Undetectable | Undetectable | Undetectable |
| | biochar | (<0.01 ppm) | (<0.01 ppm) | (<0.01 ppm) |

The data shows the strong capability of cilantro biochar to reduce lead to undetectable levels in the first 30 minutes, whereas the cilantro leaves did not have an appreciable reduction even after a longer duration. In comparison, the filter material extracted from commercially available Brita® filter was able to reduce lead by 57.2% in 30 minutes, 74.1% in 2 hours and down to undetectable levels at 24 hours. The lead sorption capacity of cilantro biochar, under the conditions of this experiment, expressed in milligrams of lead removed/kilograms of biochar was 163.6 mg/kg.

1.7 ppm lead contaminated aqueous solution was prepared from 1000 ppm lead in dilute Nitric Acid stock solution.

Parsley, carrot tops (also commonly referred to as carrot greens or carrot leaves) and carrots were purchased at a Woodbury, Minn. local grocery store. The carrots were juiced in a Breville juicer and carrot pulp was generated.

To create biochar, the same process as described above for cilantro biochar was followed.

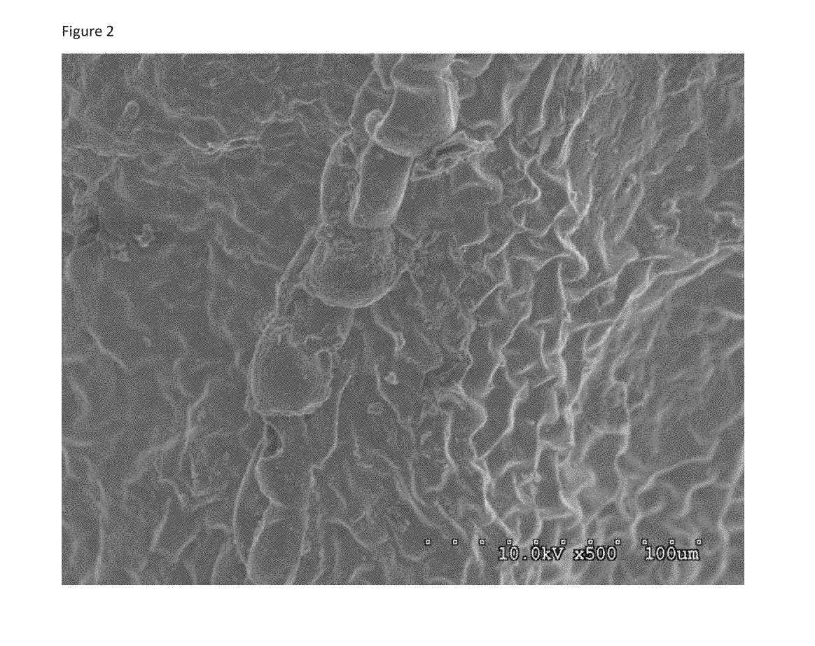

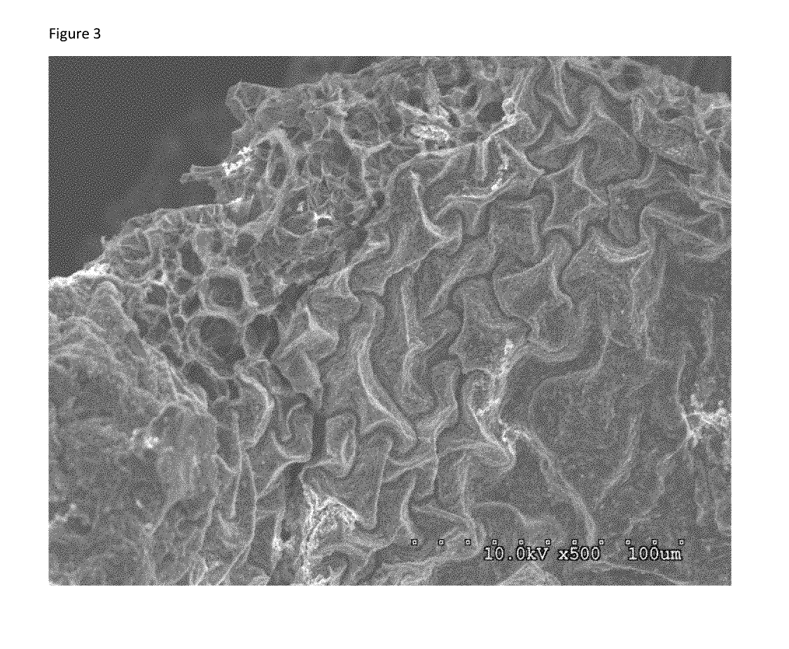

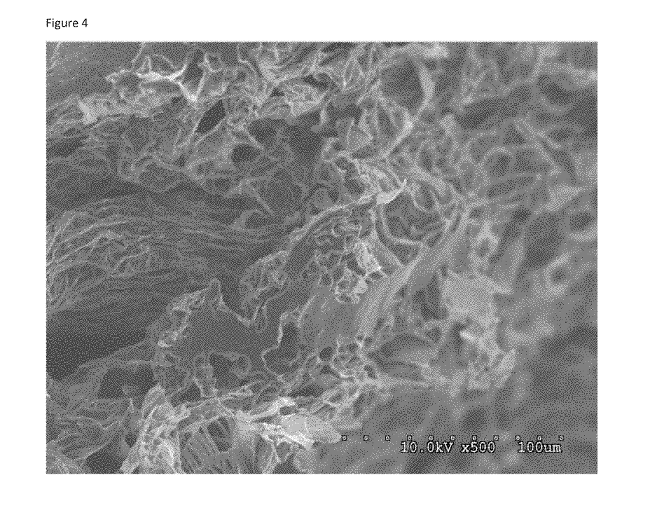

FIGS. 2, 3 and 4 are Scanning Electron Micrographs (SEM) of the resulting parsley, carrot tops and carrot pulp biochars, respectively, at a magnification of 500×.

Table 3 shows the BET (N₂) surface area of the three biochars:

| Material | Surface Area (m²/g) |
|---|---|
| Parsley biochar | 483 |
| Carrot tops biochar | 531 |
| Carrot pulp biochar | 282 |

### Example 2 (2)

80 ml of 1.7 ppm lead contaminated water was poured into 2 labeled beakers. One tablespoon Parsley biochar was added to the two beakers. After 24 hours about 15 ml of water was decanted off from each of the beakers into disposable cups lined with coffee filter to filter any solids out. The filtered water was poured into labeled test vials for elemental analysis to measure lead levels.

### Example 3 (3)

80 ml of 1.7 ppm lead contaminated water was poured into 2 labeled beakers. One tablespoon Carrot tops biochar was added to the two beakers. After 24 hours about 15 ml of water was decanted off from each of the beakers into disposable cups lined with coffee filter to filter any solids out. The filtered water was poured into labeled test vials for elemental analysis to measure lead levels.

### Example 4 (4)

80 ml of 1.7 ppm lead contaminated water was poured into 2 labeled beakers. One tablespoon Carrot pulp biochar was added to the two beakers. After 24 hours about 15 ml of water was decanted off from each of the beakers into disposable cups lined with coffee filter to filter any solids out. The filtered water was poured into labeled test vials for elemental analysis to measure lead levels.

ICP average lead content for the 1.7 ppm reference solution was measured to be 1.766 ppm

Table 2 shows the ICP data on lead content after 24 hours. Each reading is the average of the two measurements.

| | | ppm Lead at 24 | % reduction |
|---|---|---|---|
| Example | Material | hours | in Lead |
| 2 | Parsley biochar | 0.208 ppm | 88% |
| 3 | Carrot tops biochar | Less than 0.01 ppm | Over 99% |
| 4 | Carrot pulp biochar | 0.588 ppm | 67% |

The data shows the capability of other biochars of the Apiaceae plant family to reduce lead levels in contaminated water.

What is claimed is:

1. A biochar comprising a biochar of one or more plant members of the Apiaceae plant family.

2. The biochar of claim 1, wherein the one or more plant members is cilantro.

3. The biochar of claim 1 having a BET surface area greater than about 500 m²/g.

4. The biochar of claim 1 at least a portion of which is porous.

5. A cilantro biochar.

6. A method of purifying a solution comprising bringing the solution in contact with an Apiaceae biochar.

7. The method of claim 6, wherein the solution is water.

8. The method of claim 6, wherein bringing the solution in contact with the Apiaceae biochar is configured to at least partially remove one or more of any lead, copper, zinc, cadmium, nickel, chromium, iron, aluminum, cobalt, magnesium, and mercury that may be present in the solution.

9. The method of claim 6, wherein the solution comprises a detectable quantity of lead and bringing the solution in contact with the Apiaceae biochar removes the detectable quantity of lead, so that any quantity of lead remaining in the solution is substantially undetectable.

10. The method of claim 6, wherein the Apiaceae biochar is made by thermochemically converting one or more plant members of the Apiaceae plant family.

11. The method of claim 10, wherein the thermochemical conversion comprises pyrolysis.

12. A method of purifying water contaminated with lead, comprising the steps of:
thermochemically converting cilantro to biochar; and exposing the lead contaminated water to the cilantro biochar.

13. The method of claim 12, wherein the step of thermochemically converting cilantro to biochar comprises pyrolyzing or burning or charring of cilantro.

14. A filter structure for filtering solutions comprising the biochar of claim 1.

15. The biochar of claim 1, wherein the one or more plant members is carrot.

16. A biochar from carrot leaves.
